(19) United States
(12) Patent Application Publication
(10) Pub. No.: US 2026/0030473 A1
(43) Pub. Date: Jan. 29, 2026

(54) NEAR-FIELD COMMUNICATION METHOD AND DEVICE

(71) Applicant: STMicroelectronics International N.V., Geneva (CH)

(72) Inventors: Arach MOHAMMED BRAHIM, Antibes (FR); Jean-Marc GRIMAUD, Biot (FR)

(73) Assignee: STMicroelectronics International N.V., Geneva (CH)

(21) Appl. No.: 19/271,042

(22) Filed: Jul. 16, 2025

(30) Foreign Application Priority Data
Jul. 26, 2024 (EP) EP24315361.6
Oct. 1, 2024 (FR) FR2410563

(51) Int. Cl. G06K 19/07; G06K 7/10; H04B 5/77

(52) U.S. Cl. CPC G06K 19/0723; G06K 7/10237; G06K 7/10297; H04B 5/77

(57) ABSTRACT

A first device operates in card mode and includes an NFC controller. A second device operates in reader mode. In an NFC communication method, the first device exits an observer mode on reception by the NFC controller of content of a captured sequence of a radio frequency field.

### PRIORITY CLAIM

This application claims the priority benefit of European Application for Patent No. 24315361.6, filed on Jul. 26, 2024, and claims the priority benefit of French Application for Patent No. FR2410563, filed on Oct. 1, 2024, the contents of which are hereby incorporated by reference in their entireties to the maximum extent allowable by law.

### TECHNICAL FIELD

The present disclosure generally concerns electronic circuits and devices and, in particular, electronic circuits and devices configured to implement a wireless communication. The present disclosure more particularly relates to near-field communications (NFC) and to their implementations.

### BACKGROUND

It is more and more common to use wireless communications to transmit data between two, or more than two, electronic devices. A type of wireless communication concerned herein is a near-field communication (NFC), also referred to herein as an NFC communication.

More and more transactions are implemented by wireless communications, such as communications using a near-field communication technology. The communication protocols implemented during such wireless communications are constantly evolving.

To implement such an NFC communication, a first electronic device can operate in a so-called “card” or “card emulation” mode, and a second one can operate in a so-called “reader” or “terminal” mode. Such electronic devices are, for example, smart or advanced cell phones (smartphones).

It would be desirable to be able to improve, at least partly, certain aspects of the protection of NFC-type wireless communications between electronic devices.

There exists a need for improved and faster wireless communications.

There exists a need for improved and faster NFC communications.

There exists a need for electronic devices implementing such communications.

There exists a need for systems comprising at least two electronic devices implementing such communications.

There is a need to overcome all or part of the disadvantages of known wireless communications.

There is a need to overcome all or part of the disadvantages of known NFC communications.

### SUMMARY

An embodiment provides a method of NFC communication between a first device in card mode, comprising an NFC controller, and a second device in reader mode, wherein said first device exits an observer mode upon reception by said NFC controller of a content of a captured sequence of a radio frequency field.

An embodiment provides an electronic device configured to operate as a first device in an NFC communication method between said first device in card mode, comprising an NFC controller, and a second device in reader mode, wherein said first device exits an observer mode upon reception by said NFC controller of content of a captured sequence of a radio frequency field.

An embodiment provides an electronic system comprising a first electronic device and a second electronic device, the system being configured to implement an NFC communication method between said first device in card mode, comprising an NFC controller, and said second device in reader mode, wherein said first device exits an observer mode upon reception by said NFC controller of content in a captured sequence of a radio frequency field.

According to an embodiment, said sequence forms part of a polling frame transmitted by said second device.

According to an embodiment, said NFC controller detects the content of said sequence by comparison with one or a plurality of reference contents that it stores in memory.

According to an embodiment, said reference contents stored in memory in the NFC controller are sent thereto by an application processor of said first device.

According to an embodiment, said application processor of said first device is configured to trigger said observer mode.

According to an embodiment, upon reception of said content, the NFC controller is configured to indicate, to said application processor, a suspension of the observer mode.

According to an embodiment, said content is at the beginning of a first polling frame.

According to an embodiment, at the end of an NFC communication, the NFC controller is configured to re-enter the observer mode after a predefined delay.

Another embodiment provides a computer program product comprising program code instructions recorded on a medium usable in a computer, comprising: computer-readable programming means for implementing the previously-described method when said program is running on a computer.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows an embodiment of an electronic device configured to implement an NFC communication;

FIG. 2 shows an embodiment of an electronic system configured to implement an NFC communication;

FIG. 3 shows a conventional method of implementing an NFC communication; and

FIG. 4 shows an implementation mode of an NFC communication method.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

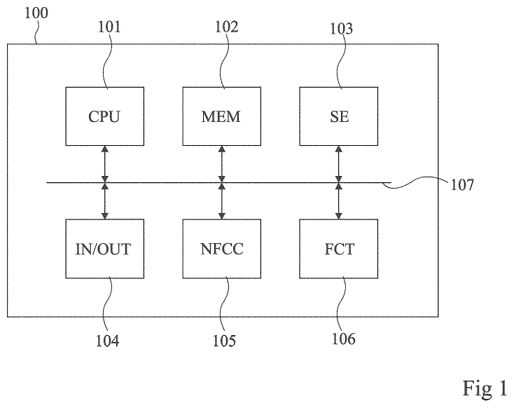

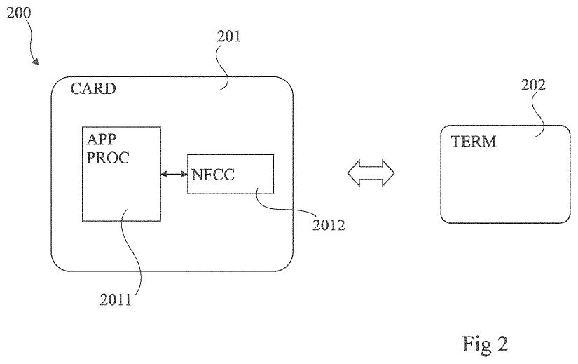

The embodiments described hereafter concern the implementation of a wireless communication, and more particularly the implementation of a faster NFC communication. The present disclosure more particularly applies to portable devices implementing an NFC communication. The card side, that is, the device operating in “card” or in “card emulation” mode is more specifically considered, while another piece of equipment in the system operates in “reader” mode. This equipment operating in reader mode may be any suitable equipment, including another phone operating in reader mode. Devices equipped with a card emulation mode include smart or advanced cell phones (smartphones). Such phones can besides operate either in reader mode, or in card mode. Such devices are described in relation with FIG. 1. An NFC communication and an electronic system implementing it are described in relation with FIG. 2.

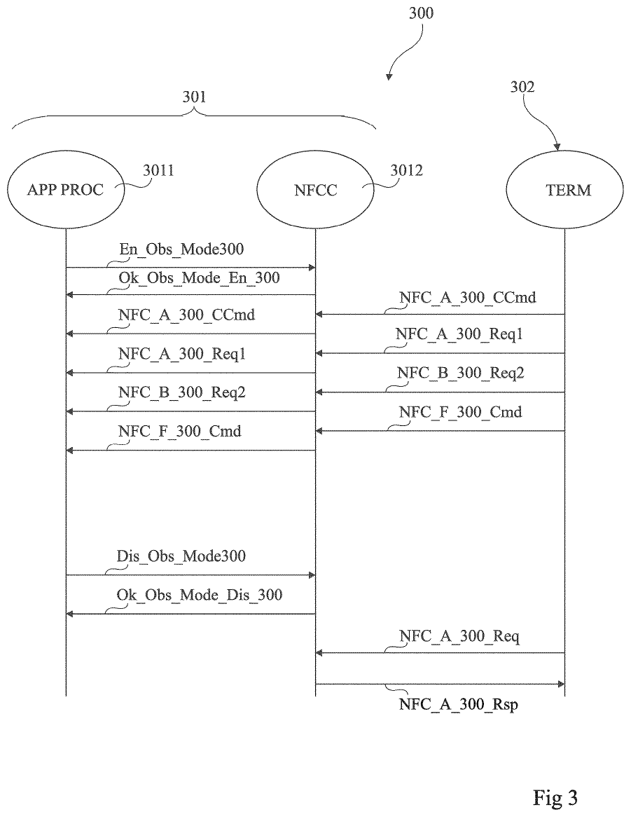

These embodiments concern a recent development of NFC communication protocols. In these recent developments, when a portable device is in card mode (it will be referred to hereafter as a device, as a device in card mode, as a card or card device), it is likely to enter a listening or observer mode, that is, a mode in which it “observes” its environment in order to detect a reader emitting a radio-frequency field, but in which it is not configured to respond to stimuli. However, the use of such an observer mode may slow down an NFC communication. The operation of such a mode is described in further detail in relation with FIGS. 2 and 3.

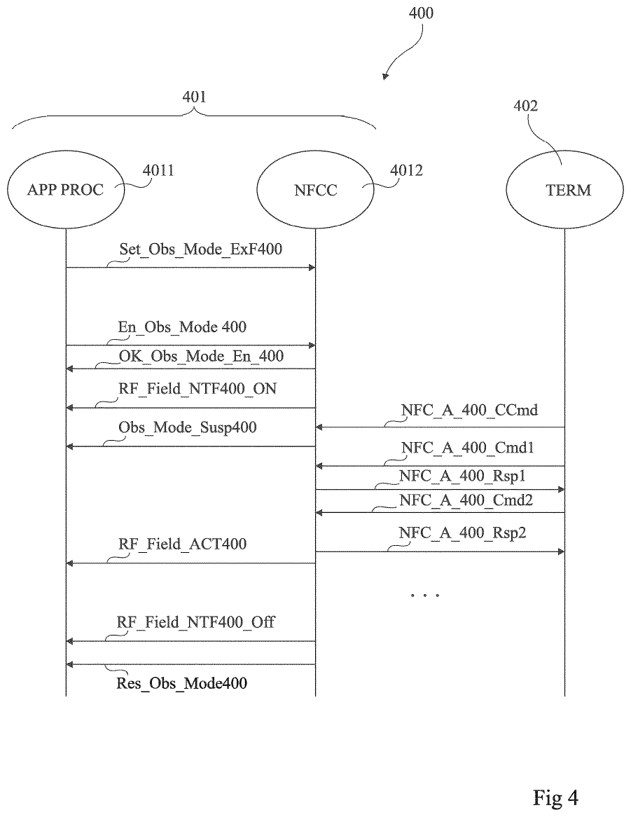

The solution provided herein comprises detecting a specific command to automatically exit an observer mode. In other words, the invention proposes exiting the observer mode upon the detection of a specific content in a received processed command. This solution is described in detail in relation with FIG. 4.

The embodiments described hereinafter are particularly adapted to any electronic device which implements an NFC communication in “card” mode, such as a cell phone, a smartphone, a portable electronic device of connected watch or electronic cigarette type.

Further, the above-described embodiments are particularly adapted to being used in any type of industrial market where an NFC communication is used. More particularly, such an NFC communication may be intended for: the automotive industry, for example in the field of automotive electrification or in the field of advanced driver assistance systems (ADAS); industry, for example in the field of green energy, in the field of infrastructure electrification, of the Internet of Things (IoT) and of smart homes, where electricity and energy consumption and data exchange are key elements; and the personal electronics industry, for example in the field of mobile telephony and of the Internet of Things (IoT), as well as in the field of high-speed interfaces.

FIG. 1 is a block diagram very schematically showing an architecture of an example of an electronic device 100 configured to implement an NFC communication method.

Electronic device 100 comprises a processor 101 (CPU) configured to implement various processing operations on data stored in memories and/or supplied by other circuits of device 100. According to an embodiment, processor 101 is configured to implement an NFC communication method. According to a specific embodiment, processor 101 is configured to implement one or a plurality of applications, themselves configured to implement NFC communications or transactions, in which case processor 101 can be referred to as an application processor.

Electronic device 100 further comprises different types of memories 102 (MEM), including, for example, a non-volatile memory, a volatile memory, and/or a read-only memory. Each memory 102 is configured to store different types of data.

Electronic device 100 further comprises, for example, a secure element 103 (SE) configured to handle sensitive and/or secret data. Secure element 103 may comprise its own processor(s), its own memory or memories, etc. According to an embodiment, processor 101 is configured to implement an NFC communication method. According to a specific embodiment, secure element 103 may comprise a processor configured to implement one or a plurality of applications, themselves configured to implement NFC communications or transactions, in which case the processor of secure element 103 can be referred to as an application processor.

Electronic device 100 may further comprise interface circuits 104 (IN/OUT) configured to send and/or to receive data originating from outside device 100. Interface circuits 104 may further be configured to implement a data display, for example, a display screen.

According to an embodiment, the electronic device comprises NFC circuits 105 (NFCC). Circuits 105 comprise an NFC controller configured to exchange data with one or a plurality of other electronic devices during the implementation of an NFC communication. According to an example, the controller comprises components enabling to implement an NFC communication. According to an embodiment, the NFC controller is configured to receive commands from the processor configured to implement one or a plurality of applications using an NFC communication, such as processor 101 or secure element 103. NFC circuits 105 further comprise circuits configured to generate and to capture a radio frequency electromagnetic field. According to an embodiment, the NFC controller comprises data storage means.

Electronic device 100 further comprises various circuits 106 (FCT) configured to perform different functions. As an example, circuits 106 may comprise measurement circuits, data conversion circuits, etc.

Electronic device 100 further comprises one or a plurality of data buses 107 configured to transfer data between its various components.

According to a specific example, electronic device 100 is configured to implement computer programs, and in particular a computer program enabling to implement a wireless communication method, for example a computer program enabling to implement a wireless communication method on the terminal side and/or on the card side.

More precisely, electronic device 100 is configured to implement at least one computer program product comprising program code instructions recorded on a medium usable in a computer, comprising computer-readable programming means for implementing the wireless communication method as a terminal device and/or as a card device when said program is running on a computer.

FIG. 2 shows, very schematically and in the form of blocks, an example of a system 200 implementing an NFC communication.

System 200 comprises a first device 201 (CARD) and a second device 202 (TERM). Each device 201, 202 is of the type of the device 100 described in relation with FIG. 1.

Device 201 is a card-type device, that is, an electronic device operating in “card” or “card emulation” mode. Device 201 is referred to hereafter as a card device.

Device 202 is a reader-type device, that is, an electronic device operating in “reader” or “terminal” mode. Device 202 is referred to hereafter as a reader device.

According to an embodiment, device 201 comprises at least one application processor 2011 (APP PROC) and one NFC controller 2012 (NFCC). Application processor 2011 is configured to implement one or a plurality of applications capable of using an NFC communication, for example to implement a transaction (for example, banking, transport, access, etc.). As for NFC controller 2012, it is configured to practically implement an NFC communication.

Even though this is not shown in FIG. 2, device 202 also comprises at least one NFC controller for implementing an NFC communication, and, for example, a processor.

An NFC communication uses radio frequency (RF) signals transmitted, by the devices implementing the communication, by means of antennas of an oscillating/resonant circuit. When reader device 202 emits an electromagnetic field to initiate a communication with card device 201, this field is captured by card device 201 as soon as it is within range. This field is detected by card device 201.

Generally speaking, from a communication protocol point of view, an NFC communication starts with the sending, by the reader device, of one or a plurality of polling frames. Once this polling frame is captured by a card device, this card device responds thereto and the NFC communication is initiated. The NFC communication then takes the form of an exchange of data sequences forming requests and responses. There exist several types of polling frames, some of which are defined by standards, among which include type-A frames, type-B frames, or type-F frames. These types of polling frame are defined, for example, by the bytes transmitted by a frame. Other bytes of a frame may enable to define the length of the authorized responses.

Further, recent developments have led to the creation of a new operating mode of an electronic device configured to implement an NFC communication. This operating mode is a listening mode, or “observer” mode, during which an electronic device captures data sequences, seeks to interpret the various protocols that it captures and, when it detects a command according to a protocol that it can support, configures itself on this protocol so that the reader device can initiate a transaction. When a card device is operating in such a mode, its NFC controller is configured to receive, capture, or observe possible polling frames transmitted by a reader device which is likely to have it in its field. FIG. 3 illustrates with a communications exchange diagram the beginning of a current NFC communication in greater detail, and shows, in particular, how the observer mode works. FIG. 4 illustrates with a communications exchange diagram the beginning of an implementation mode of an NFC communication method in greater detail, and shows, in particular, how the observer mode works.

FIG. 3 very schematically shows an implementation mode of an NFC communication method 300 within an electronic system of the type of the system 200 described in relation with FIG. 2.

More specifically, NFC communication 300 is implemented between a reader device 302 of the type of the reader device 202 described in relation with FIG. 2, and a card device 301 of the type of the device 201 described in relation with FIG. 2. Card device 301 comprises an application processor 3011 of the type of the processor 2011 described in relation with FIG. 2 and an NFC controller 3012 of the type of the NFC controller 2012 described in relation with FIG. 2. FIG. 3 shows the data communication exchanges between reader device 302, application processor 3011, and NFC controller 3012.

In an initial state, no communication is initiated between card device 301 and reader device 302. Card device 301 is thus waiting for a request to implement an NFC communication. Card device 301 can thus enter an observer mode. More specifically, card device 301 can set its NFC controller to an observer mode. For this purpose, application processor 3011 triggers the observer mode of NFC controller 3012 by sending a command, or request, En_Obs_Mode300 thereto. NFC controller 3012 receives this command, enters the observer mode and may, for example, respond to application processor 3011 with a confirmation Ok_Obs_Mode_EN_300. When it is in this observer mode, NFC controller 3012 begins to “observe” a possible field emitted by reader device 302.

As soon as NFC controller 3012 receives a field emitted by reader device 302 and receives commands and requests, it directly transmits the commands and requests to application processor 3011 without responding thereto, and, for example, without analyzing them. When in this observer mode, NFC controller 3012 is not authorized to send data.

In the example of FIG. 3, reader device 302 sends a number of polling frames comprising a number of requests and commands noted NFC-A-300-CCmd, NFC-A-300-Req1, NFC-B-300-Req2, and NFC-F-300-Cmd. According to an example, if reader device 302 is configured to implement an NFC communication by using a plurality of different communication protocols, it may send polling frames according to the different protocols that it supports. All these requests and commands, noted NFC-A-300-CCmd, NFC-A-300-Req1, NFC-B-300-Req2, and NFC-F-300-Cmd, are received by NFC controller 3012 and are then directly transmitted to application processor 3011. Application processor 3011 then analyzes the content of these requests and commands noted NFC-A-300-CCmd, NFC-A-300-Req1, NFC-B-300-Req2, and NFC-F-300-Cmd and decides whether or not it wishes to start a communication with reader device 302.

If application processor 3011 decides to start a communication with reader device 302, it sends a command, or request, Dis_Obs_Mode300 to the NFC controller so that it exits the observer mode. NFC controller 3012 receives this command, exits the observer mode, and may, for example, respond to application processor 3011 with a confirmation Ok_Obs_Mode_Dis_300. According to a variant, NFC controller 3012 may be taken out of the observer mode by a processor different from application processor 3011.

According to a specific example, the listening mode, or observer mode, is an operating mode of the NFC controller present in electronic devices embedding the operating system known under denomination “Android”.

Once NFC controller 3012 is in a normal operating mode, that is, an operating mode in which it can implement an NFC communication, it can respond to terminal device 302 when it receives commands and requests therefrom.

In the example of FIG. 3, reader device 302 sends a request NFC-A-300-Req and NFC controller 3012 responds with a response NFC-A-300-Rsp. According to an example, NFC controller 3012 may directly respond, or may consult application processor 3011 to find out which response to send to reader device 302. According to an example, application processor 3011 may select, according to the type of protocol used by reader device 302 and/or according to the content of the polling frame(s) sent by reader device 302, the application implementing the NFC communication and let this application generate a response for reader device 302.

A disadvantage of NFC communication method 300 is that the use of the observer mode wastes time for the NFC communication, and in particular delays the completion of the NFC communication. The implementation mode described in relation with FIG. 4 aims at overcoming this problem.

FIG. 4 very schematically shows an implementation mode of an NFC communication method 400 within an electronic system of the type of the system 200 described in relation with FIG. 2.

More particularly, NFC communication 400 is implemented between a reader device 402 of the type of the reader device 202 described in relation with FIG. 2, and a card device 401 of the type of the device 201 described in relation with FIG. 2. Card device 401 comprises an application processor 4011 of the type of the processor 2011 described in relation with FIG. 2 and an NFC controller 4012 of the type of the NFC controller 2012 described in relation with FIG. 2. FIG. 4 shows the data exchanges between reader device 402, application processor 4011, and NFC controller 4012.

The embodiments described herein enable card device 401 to exit the listening mode, or observer mode, based on the recognition of content in a sequence transmitted by reader device 402 and recognized by the NFC controller 4012 of card device 401. Thus, application processor 4011 does not need to analyze all protocols.

Thus, a preparation step, or initialization step, is first implemented. Application processor 4011 sends NFC controller 4012 a list of reference contents of a data sequence, of a command, or of a request, which can be recognized as observer mode stop signals. In the example of FIG. 4, application processor 4011 sends a command Set_Obs_Mode_ExF400 comprising said list of reference contents. According to an example, these contents form part of NFC communication protocol polling frames.

This is referred to as the content of a data sequence, of a command, or of a request, data or a group of data included in a data sequence, a command, or a request.

According to a first embodiment, the list of reference contents may be a list of complete data, that is, bit or byte strings, whole data and or sets of complete data. According to an example, each content may have a defined length and be placed at any location in a data sequence or a data frame. According to an example, each content may have a non-defined length and be placed at any location in a data sequence or in a data frame.

According to a specific example, command Set_Obs_Mode_ExF400 may comprise, for example, different pieces of information, among which: a list of reference content, each characterized by a type, a length, and a value; a value of delays for restoring the observer mode; and a value of a number of data sequences following a reference content.

According to a second embodiment, the list of reference contents may be a list of data masks. A mask may be a piece of data, for example a prefix of a piece of data, or a set of pieces of data.

This preparation step may be carried out at any time in the life of NFC controller 4012, and, more specifically, this list may be updated by adding or removing content at any time in the life of NFC controller 4012.

In a state prior to the NFC communication, card device 401 is thus waiting for a request to implement an NFC communication. Card device 401 can thus enter an observer mode. More specifically, card device 401 can set its NFC controller to an observer mode. For this purpose, application processor 4011 launches the observer mode of NFC controller 4012 by sending a command, or request, En_Obs_Mode400 thereto. NFC controller 4012 receives this command, enters the observer mode, and may, for example, respond to application processor 4011 with a confirmation Ok_Obs_Mode_EN_400. When it is in this observer mode, NFC controller 4012 is configured to observe a possible field emitted by reader device 302 and not to respond.

Reader device 402 generates a radio frequency field to attempt starting a communication with a card device. NFC controller 4012 captures this field. According to an example, NFC controller 4012 may indicate to application processor 4011 that it is capturing a field by sending a notification RF_Field_NTF400_ON thereto.

Reader device 402 sends one or a plurality of polling frames corresponding to one or a plurality of different communication protocols, while waiting for a response. In FIG. 4, reader device 402 sends at least one polling frame having a communication protocol compatible with card device 401. More particularly, reader device 402 starts by sending at least one data sequence NFC-A-400-CCmd having its content forming part of the list stored in NFC controller 4012.

Upon reception of data sequence NFC-A-400-CCmd, NFC controller 4012 detects the content and automatically suspends the observer mode. According to an example, NFC controller 4012 may indicate to application processor 4011 that it has suspended the observer mode by sending a notification Obs_Mode_Susp400.

According to a specific example, command Obs_Mode_Susp400 may comprise, for example, various information, among which: a value indicating the type of command Obs_Mode_Susp400; a value indicating the length of command Obs_Mode_Susp400; and a value indicating the received content which has triggered the sending of command Obs_Mode_Susp400.

Once NFC controller 3012 has suspended the observer mode and is in a normal operating mode, that is, an operating mode in which it can implement an NFC communication, it can respond to terminal device 302 when it receives commands and requests therefrom. According to an example, reader device 402 sends a command, or request, NFC-A-400-Cmd1 or NFC-A-400-Cmd2 to which the NFC controller responds with a response NFC-A-400-Rsp1 or NFC-A-400-Rsp2. NFC controller 4012 may further indicate to application processor 4011 that an NFC communication is ongoing with reader device 402, for example by sending a notification RF_Field_ACT400. According to an example, NFC controller 4012 may also send, to the reader device, response wait requests when it needs to poll application processor 4011 before responding to reader device 402.

The rest of the NFC communication may, for example, take place with application processor 4011 being included. The latter may, for example, select an application and let this application implement the NFC communication with NFC controller 4012.

Once the NFC communication has been completed and is over, reader device 402 stops its radio frequency field. According to an example, NFC controller 4012 may indicate to application processor 4011 that it is no longer capturing fields by sending a notification RF_Field_NTF400_OFF thereto. According to an example, the NFC controller may further re-enter, or return to, the observer mode. According to an example, the NFC controller may indicate this to application processor 4011 by sending it a notification Res_Obs_Mode400.

According to a specific example, command Obs_Mode_Susp400 may, for example, comprise an empty data field.

According to a variant, NFC controller 4012 may wait for a predefined delay after the reception of an NFC sequence, and resume the observer mode if it receives no other sequences from reader device 402. According to an example, this predefined delay may be zero.

An advantage provided by the embodiments of FIG. 4 is that they enable to avoid waiting for the analysis of polling frames by the application processor to start an NFC communication, and thus to save time in the completion of the NFC communication.

Another advantage of these embodiments is the backward compatibility with existing devices, provided for their internal program(s) to be updatable. Indeed, no change is required on the reader side.

Various embodiments and variants have been described. Those skilled in the art will understand that certain features of these various embodiments and variants may be combined, and other variants will occur to those skilled in the art.

Among possible variants, there can be noted: the possibility of responding to a so-called “proprietary” frame to exit the observer mode; and a hardware or hardware and software implementation on the card device side (then requiring a structural modification).

Further, although “Android” devices have been taken as an example, the described solutions apply and can be transposed to any other system in which similar problems are posed.

Finally, the practical implementation of the described embodiments and variants is within the abilities of those skilled in the art based on the functional indications given hereabove.

1. An NFC communication method between a first device configured to operate in card mode, said first device including an NFC controller, and a second device configured to operate in reader mode, comprising: receiving by said NFC controller a captured sequence of a radio frequency field; identifying a content of the captured sequence; and in response to identifying the content then having said first device exit an observer mode.

2. The method according to claim 1, wherein said captured sequence forms part of a polling frame transmitted by said second device.

3. The method according to claim 1, wherein identifying the content of said captured sequence comprises comparing, by the NFC controller, the content with one or a plurality of reference contents stored in memory.

4. The method according to claim 3, further comprising sending said reference contents for storage in memory of the NFC controller by an application processor of said first device.

5. The method according to claim 4, wherein said application processor of said first device is configured to trigger said observer mode.

6. The method according to claim 4, further comprising, upon reception of said content, indicating by the NFC controller to said application processor a suspension of the observer mode.

7. The method according to claim 1, wherein said content is at the beginning of a first polling frame.

8. The method according to claim 1, further comprising, at an end of an NFC communication, having the NFC controller to re-enter the observer mode after a predefined delay.

9. An electronic device configured to operate as a first device in an NFC communication method between said first device in card mode and a second device in reader mode, said first device including an NFC controller, and wherein said first device is configured to receive by said NFC controller a captured sequence of a radio frequency field, identify a content of the captured sequence; and in response to identifying the content then exit an observer mode.

10. The device according to claim 9, wherein said captured sequence forms part of a polling frame transmitted by said second device.

11. The device according to claim 9, wherein said NFC controller is configured to identify the content of said captured sequence by comparing the content with one or a plurality of reference contents stored in memory.

12. The device according to claim 11, wherein said reference contents stored in memory in the NFC controller are received from an application processor of said first device.

13. The device according to claim 12, wherein said application processor of said first device is configured to trigger said observer mode.

14. The device according to claim 11, wherein, upon reception of said content, the NFC controller is configured to indicate, to said application processor, a suspension of the observer mode.

15. The device according to claim 9, wherein said content is at the beginning of a first polling frame.

16. The device according to claim 9, wherein the NFC controller is configured, at the end of an NFC communication, to re-enter the observer mode after a predefined delay.

17. An electronic system, comprising:
a first device; and
a second device;
wherein the first and second devices are configured to implement an NFC communication with the first device operating in card mode and said second device operating in reader mode;
wherein the first device includes an NFC controller configured to receive a captured sequence of a radio frequency field; and
wherein said first device is configured to identify a content of the captured sequence; and in response to identifying the content then exit an observer mode.

18. The system according to claim 17, wherein said sequence forms part of a polling frame transmitted by said second device.

19. The system according to claim 17, wherein said NFC controller identifies the content of said sequence by comparison with one or a plurality of reference contents stored in memory.

20. The system according to claim 19, wherein said reference contents stored in memory in the NFC controller are sent thereto by an application processor of said first device.

21. The system according to claim 20, wherein said application processor of said first device is configured to trigger said observer mode.

22. The system according to claim 19, wherein the NFC controller is configured, upon reception of said content, to indicate to said application processor a suspension of the observer mode.

23. The system according to claim 17, wherein said content is at the beginning of a first polling frame.

24. The system according to claim 17, wherein the NFC controller is configured, at the end of an NFC communication, to re-enter the observer mode after a predefined delay.
